(19) United States
(12) Patent Application Publication
(10) Pub. No.: US 2015/0068633 A1
(43) Pub. Date: Mar. 12, 2015

(54) TESTABLE COMPOSITE SYSTEMS FOR THE REINFORCEMENT OF METALLIC STRUCTURES FOR CONTAINING FLUIDS

(71) Applicant: Neptune Research, Inc., Riviera Beach, FL (US)

(72) Inventors: Christopher J. Lazzara, Palm Beach, FL (US); Richard J. Lazzara, Palm Beach, FL (US); Venkatachala S. Minnikanti, Delray Beach, FL (US); Davie Peguero, Lake Park, FL (US); James R. Schwarz, West Palm Beach, FL (US)

(21) Appl. No.: 14/478,505

(22) Filed: Sep. 5, 2014

Related U.S. Application Data
(60) Provisional application No. 61/874,586, filed on Sep. 6, 2013.

(51) Int. Cl. F16L 55/168

(52) U.S. Cl. CPC F16L 55/1686
USPC 138/99

(57) ABSTRACT

A composite system for reinforcing a section of a curved metallic structure configured to contain fluids comprises a fabric carrier configured to be saturated with a uniformly dispersed reactive precursor. The reactive precursor chemically configured to activate and harden after removal of the reactive precursor from a protective packaging. The reactive precursor includes a radiopaque substance within a range of about 3 percent to about 50 percent by weight of the reactive precursor. The fabric carrier is adapted to be applied in overlapping layers to a surface of a curved metallic structure.

### CROSS-REFERENCE To RELATED APPLICATIONS

This application claims priority to and the benefits of U.S. Patent Application No. 61/874,586, filed Sep. 6, 2013, which is hereby incorporated by reference herein in its entirety.

### FIELD OF THE INVENTION

The present invention relates generally to composite materials and, more particularly, testable multi-layer composite systems for the reinforcement of structures for containing fluids.

### BACKGROUND OF THE INVENTION

Conduit assemblies, such as pipelines and hydraulic circuits, are used to transport an assortment of fluids, such as water, oil, various natural and synthetic gases, sewage, slurry, hazardous materials, and the like. Conduit assemblies are formed from a variety of materials, including, for example, concrete, plastic (e.g., polyvinyl chloride, polyethylene), and various metallic materials, such as iron, copper, and steel. Containment structures, such as storage tanks, are used to store an assortment of fluids, such as oil, water, chemicals, various natural and synthetic fluids, sewage, hazardous materials, and the like. Containment structures are formed from a variety of materials, including concrete, plastic, and metallic materials, such as iron, copper, aluminum, and steel.

Conduit assemblies and containment structures are often exposed to harsh environments and are often under loads that can cause the assemblies and structures to degrade to the point of needing to be repaired and reinforced. There is a need for improved repair and reinforcement systems that are quick, versatile, durable, minimally disruptive, and cost-effective that can also be inspected to determine the integrity of the composite system.

### SUMMARY OF THE INVENTION

According to some aspects of the invention, a repair kit for the reinforcement of a section of a curved metallic structure for containing fluids comprises a moisture impervious bag and a woven fabric carrier including a continuous reinforcing fiber. The woven fabric carrier is pre-impregnated with a uniformly dispersed polyurethane resin reactive precursor. The woven fabric carrier is sealed in the moisture impervious bag to isolate the reactive precursor from premature chemical activation. The reactive precursor is chemically configured to activate and harden after removal of the woven fabric carrier from the moisture-impervious bag. The reactive precursor includes a radiopaque substance within a range of about 3 percent to about 15 percent by weight of the reactive precursor. The reactive precursor is uniformly dispersed within the woven fabric carrier. The radiopaque substance is suspended within the reactive precursor. The woven fabric carrier is adapted to be applied to a curved metallic structure in overlapping layers of the fabric carrier.

According to another aspect of the invention, a composite system for reinforcing a section of a curved metallic structure configured to contain fluids comprises a fabric carrier configured to be saturated with a uniformly dispersed reactive precursor. The reactive precursor is chemically configured to activate and harden after removal of the reactive precursor from a protective packaging providing an inert interior storage environment. The reactive precursor includes a radiopaque substance within a range of about 3 percent to about 50 percent by weight of the reactive precursor. The saturated fabric carrier is adapted to be applied in overlapping layers to a surface of a metallic structure after activation and before hardening of the reactive precursor such that at least a first layer of overlapping layers is allowed to bond to the surface of the metallic structure.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective-view illustration of an exemplary structure showing a composite system initially being applied to reinforce an exterior surface of a section of the structure according to at least some aspects of the present invention.

FIG. 2 is a perspective-view illustration of the exemplary structure of FIG. 1, showing the composite system being applied in overlapping layers to reinforce the section of the structure according to at least some aspects of the present invention.

FIG. 3 illustrates cross-section 3-3 from the exemplary structure of FIG. 2 including an exploded view illustrating various exemplary anomalies that form during or after the application of the composite system according to at least some aspects of the present invention.

FIG. 4 illustrates an exemplary schematic for testing a composite system applied to an exemplary pipeline assembly according to at least some aspects of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. These are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the word “including” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

A testable composite system for reinforcing and repairing a section of a curved metallic structure is desirable. For example, inspection of the integrity of repairs or reinforcements made to curved metallic structure, such as a pipeline or other fluid containment and/or transport structures, would be desirable. Integrity testing can be completed using X-ray technology where a composite system for the repair or reinforcement of the pipeline includes composite materials comprising radiopaque materials, such as barium sulfate. The radiopaque materials are added to a resinous portion of the reinforcing composite system. An exemplary composite system can include a fabric carrier impregnated or saturated with a reactive precursor, such as a resinous material that allows the fabric carrier to initially be flexible but hardens when cured. The inclusion of barium sulfate or other radiopaque substance in the resinous material allows defects in the composite system layers of the pipeline repair or reinforcement to be observed using an X-ray sensitive detector (e.g., digital X-ray detector, X-ray image plate, photographic X-ray film) upon the application of X-rays from an X-ray source (e.g., X-ray tube, radioactive source material such as ytterbium-169 or iridium-192).

Inspection of the integrity of pipeline or other curved metallic structure that has been reinforced or repaired using a composite system including a resin impregnated fabric carrier is typical characterized as a two-layer system. The first layer is the pipe or metallic structure itself. The second layer is the composite repair or reinforcement that is formed about the surface of the curved metallic structure. The X-ray source is then applied at the exposed outermost surface of the layered composite system. In a desirable aspect of the described integrity inspection, the X-ray is applied at an angle to the outermost surface of the composite system such that the X-rays are approximately tangential to the pipe or curve of the a curved metallic surface in the vicinity of the area of the composite system that is being inspected.

In some aspects, the radiopaque materials are generally uniformly dispersed throughout the resin in the resin's uncured state and within the fabric carrier before the composite system is applied for the repair or reinforcement. However, it is desirable for the radiopaque material to be uniformly dispersed following the curing or hardening of the resin as the repair or reinforcement of the curved metallic structure is being finalized. The radiopaque materials are particularly desirable to provide reflective properties upon the application of the X-ray source and subsequent detection on the X-ray detector, so that anomalies, if any, within the composite system reinforcement can be visually observed. Examples of images from the inspection of a pipe reinforced with various composite systems are provided in U.S. Patent Application No. 61/874,586, which is incorporated by reference herein in its entirety. The X-ray images from a cross-section of a composite system reinforcement of a pipe are particularly useful for showing the presence of anomalies in the composite system. The centerline of X-rays emitted from an X-ray source are desirably tangential to the curved surface of the composite system reinforcement (e.g., a series of thin overlapping layers) that was applied to the curved metallic structure. Much less desirable and unsuitable results are obtained where the centerline of X-rays emitted from an X-ray source are directed toward the center of the pipe or are directed parallel with the radius line (e.g., for a curved metallic structure). Similarly, inspecting the integrity of a composite system by directing the centerline of X-rays (emitted from an X-ray source) perpendicular to the outermost curved surface of a reinforcement composite system (e.g., applied in a series of thin overlapping layers about a curved metallic structure, such as a pipeline) is not beneficial for detecting anomalies in resin-based composite reinforcement systems.

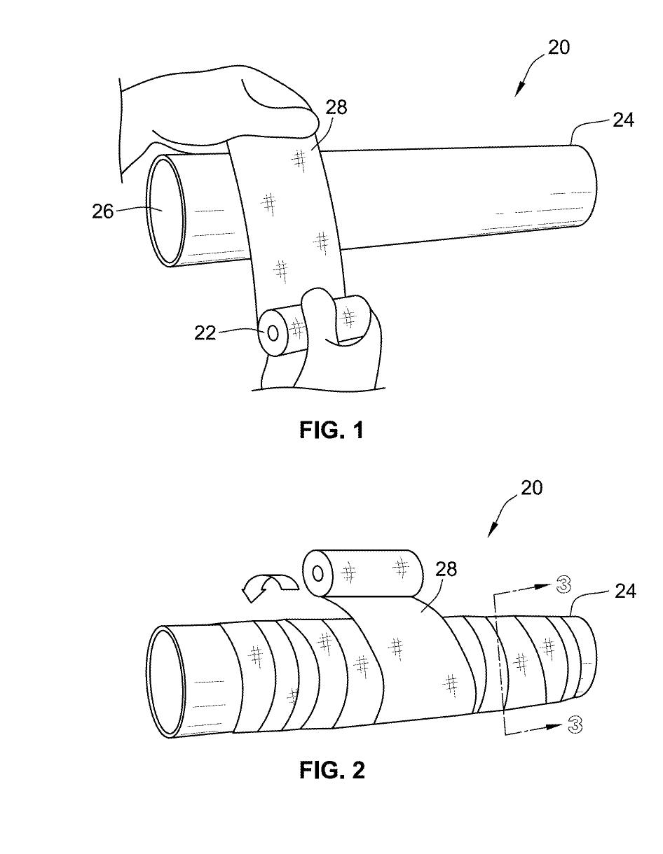

Referring to the drawings, wherein like reference numbers refer to like components throughout the several views, FIGS. 1-3 illustrate an exemplary curved metallic structure (e.g., pipeline, fluid containment structure, conduit), indicated generally at 20. The drawings presented herein are provided purely for instructional purposes, and should therefore not be considered limiting. For instance, the particular pipeline arrangement shown in FIGS. 1-3 is exemplary in nature, and not limiting by implication. By way of example, the curved metallic structure (e.g., pipeline) is intended for transporting any of an assortment of fluids, such as water, oil, natural and synthetic gases, sewage, slurry, hazardous materials, etc. However, the present disclosure may be utilized in other pipeline assemblies, such as those housing fiber optic wires, electrical cabling, etc. It is also contemplated that a curved metallic structure may include a fluid containment structure, such as an oil or water tank. In addition, the drawings presented herein are not to scale; thus, the individual and relative dimensions shown in the drawings are not to be considered limiting.

Referring now to FIG. 1, a pipeline assembly 20 may be constructed of any feasible material having sufficient strength and resiliency for the intended use of the pipeline assembly 20. By way of example, and not limitation, the pipes are fabricated from a material that can withstand significant internal and external loading, such as those that exist by reason of surrounding formations (e.g., when the pipeline assembly 20 is buried underground), as well as any additional loads exacted thereto (e.g., due to internal fluid pressures, existing constructions, varying surface loads, etc.). In the illustrated embodiment, the pipeline assembly 20 consist of elongated hollow steel cylinders having an exterior surface 24 and an interior surface 26 that may be reinforced or repaired with a resin-impregnated composite system, such as one or more of the systems described in U.S. Pat. No. 4,519,856, entitled “Resin-Cloth Structural System”; U.S. Pat. No. 5,030,493, entitled “High Strength Resin-Cloth Structural System”; U.S. Pat. No. 5,894,864, entitled “Repair or Maintenance System for Leaking Pipes or Pipe Joints”; and U.S. Pat. No. 8,522,827, entitled “Protective Seal for Pipeline Assembly”, the disclosures of which are each hereby incorporated by reference herein in their entireties. Alternatively, the pipes for the pipeline assembly can also be fabricated from other metallic and polymeric materials. Moreover, although illustrated as cylindrical components, the pipeline assembly may take on other geometric cross-sections that allow for the application of a resin impregnated composite reinforcement system to a curved metallic structure (e.g., an elliptical cross-section) without departing from the present disclosure.

A pipeline assembly 20 often comprises a series of pipes such as those shown in FIGS. 1-3, sometimes including pipes of varying cross-sections. The series of pipes joined together at joints (not shown) where each of the pipes in the series interface with the adjacent pipe and are connected. Various techniques for joining the pipes are readily available (e.g., via industrial-strength adhesives, intermeshing helical threading, boots, clamps, and other mechanical fastening means). Two adjacent pipes, in particular metal or steel pipes, are often joined by welding. By way of example, the pipes may be joined by arc welding techniques, including the various methods of shielded metal arc welding (SMAW) and gas metal arc welding (GMAW), which is sometimes referred to by its subtypes metal inert gas (MIG) welding or metal active gas (MAG) welding. The resultant weld joint extends continuously around the perimeter of the interface between the two pipes.

The joints between pipes of a pipeline assembly 20 can often be weak points that require repair or reinforcement. The joint region and the techniques for joining two adjacent pipes of a pipeline assembly can also introduce imperfect surfaces and foreign materials to the pipeline assembly. For example, in some aspects, the exterior surface 24 or an interior surface 26, or both, of a metallic pipe may be coated with a protective surface coating. Prior to joining two pipes of a pipeline assembly, any protective topcoat in the immediate vicinity of the pipe interface would typically be removed to expose the underlying steel in surrounding areas of the weld joint. A high-pressure particulate device, such as a pneumatic sandblaster, or a roughening device, such as a wire brush, power brush, may be used to remove the pipe coatings, as well as any rust, paint, and other foreign matter from the pipeline assembly. Any of these activities, particularly if not implemented properly, can lead to the introduction of foreign materials or irregularities to a pipeline assembly. The application of a resin-impregnated composite system to repair or reinforce a pipeline assembly, particularly where applied at or near a joint region can lead to the further introduction of various foreign materials (e.g., from applying the composite system, from the pipe surface itself) or air pockets (e.g., from an irregular pipe surface, delamination of resin between layers, improper curing of resin) within the composite system or between the composite system and the pipe surface. Thus, it would be desirable to have a testable composite system that allows for the inspection for any anomalies in a composite system repair or reinforcement of a pipeline assembly.

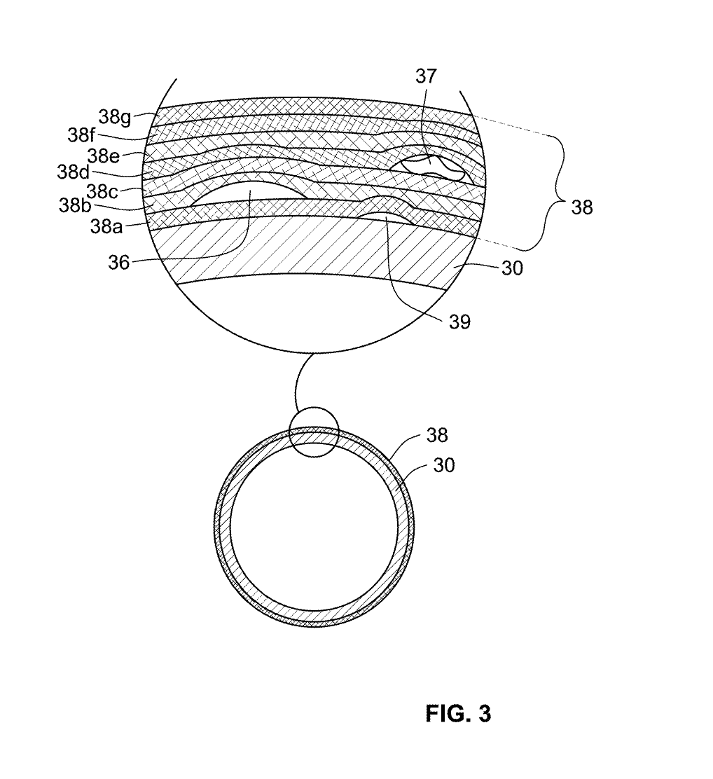

A composite system including a resin impregnated (or saturated) fabric carrier 28 (e.g., pre- or post-) for the reinforcement or repair of a curved metal structure (e.g., a pipeline) is shown in accordance with certain aspects of the present disclosure. The resin impregnated fabric carrier 28 may be stored on a roll 22. The fabric carrier 28 is initially applied to the curved metal structure that is being reinforced by applying a first end of the roll 22 to the structure as illustrated in FIG. 1 and then wrapped around such that a series of multiple thin layers of fabric carrier are applied about the outer or inner circumference of the curved structure (i.e., about the exterior 24 or interior 26). A near-finished application of a composite system with the last outermost exposed layers of fabric carrier is illustrated in FIG. 2 with a cross-section through the pipe illustrated in FIG. 3. According to some aspects, a resin impregnated fabric carrier once applied and cured to an exterior of a pipeline assembly forms a composite system reinforcement that collectively increases the outer diameter of the pipeline by less than approximately 10% of the pipeline diameter.

In some aspects, the fabric carrier is fiberglass composite material. The exemplary fiberglass composite preferably comprises a woven filament, fiberglass cloth. In accordance with certain facets of the present concept, the fiberglass composite is impregnated with a self-adhering, resinous pliable-plastic material that in some aspects is hardened by exposure to aqueous moisture (e.g., water). Examples of such fiberglass composite wraps include the Syntho-Glass® fiberglass composite system, the Syntho-Glass® NP repair system, the Syntho-Glass® 24 composite system, and the Syntho-Glass® XT fiberglass composite system, all manufactured by Neptune Research Inc., located at 3875 Fiscal Court, Ste #100, in Riviera Beach, Fla., USA. The fiberglass wraps are pre-impregnated with a water-curable polyurethane resin that is found in the commercially available Syntho-Glass® systems as modified to include the addition of radiopaque materials which are discussed below in more detail.

In some aspects, the fabric carrier is a biaxial, hybrid carbon and glass fiber composite material. In accordance with certain facets of the present concept, the carbon and glass fiber composite is impregnated with a self-adhering, resinous pliable-plastic material that in some aspects is hardened by exposure to aqueous moisture (e.g., water). Examples of such a hybrid composite wrap includes the Viper-Skin® carbon fiber composite reinforcement system as manufactured by Neptune Research Inc., located at 3875 Fiscal Court, Ste #100, in Riviera Beach, Fla., USA. The hybrid carbon and glass fiber wraps are pre-impregnated with a water-curable polyurethane resin, similar to the polyurethane resins found in the Syntho-Glass® composite systems as modified to include the addition of radiopaque materials which are discussed below in more detail.

In some aspects, the fabric carrier is a carbon fiber composite material. In accordance with certain facets of the present concept, the carbon fiber composite is saturated with an epoxy system (e.g., a two-art epoxy resin). Examples of such a carbon fiber wrap saturated with an epoxy system includes the Titan® 118 and Titan 218 carbon fiber structural repair systems and the Trans-Wrap™ carbon fiber pipeline repair system as manufactured by Neptune Research Inc., located at 3875 Fiscal Court, Ste #100, in Riviera Beach, Fla., USA. These uni-directional and bi-directional non-woven carbon fiber composite systems are saturated with a two-part epoxy (e.g., Titan™ Saturant Epoxy or Thermo-Poxy epoxy resins also available from Neptune Research, Inc.) modified to include the addition of radiopaque materials which are discussed below in more detail.

In some aspects, the fabric carrier is a biaxial, hybrid carbon and glass fiber composite material. In accordance with certain facets of the present concept, the carbon and glass fiber composite is saturated with an epoxy resin. Examples of such a hybrid composite wrap includes the Thermo-Wrap™ CF carbon fiber composite repair system as manufactured by Neptune Research Inc., located at 3875 Fiscal Court, Ste #100, in Riviera Beach, Fla., USA. The hybrid carbon and glass fiber wraps are saturated with a two-part epoxy (e.g., Thermo-Poxy epoxy resin also available from Neptune Research, Inc.) modified to include the addition of radiopaque materials which are discussed below in more detail.

In some aspects, the fabric carrier is a bidirectional, woven fiberglass tape composite material. In accordance with certain facets of the present concept, the fiberglass tape is saturated with an epoxy resin. Examples of such a composite wrap includes the Thermo-Wrap™ composite repair system as manufactured by Neptune Research Inc., located at 3875 Fiscal Court, Ste #100, in Riviera Beach, Fla., USA. The fiberglass composite wrap is saturated with a two-part epoxy (e.g., Thermo-Poxy epoxy resin also available from Neptune Research, Inc.) modified to include the addition of radiopaque materials which are discussed below in more detail.

Referring now to FIG. 3, exemplary aspects of an illustrative cross-section through a curved metallic structure for containing fluids, such as the pipeline assembly 20 illustrated in FIG. 3, are discussed in more detail. The cross-section includes a curved metallic structure 30 (e.g., a cross-section through a pipe) along with a multi-layered composite system 38 that was wrapped around the exterior side of the metallic structure that is exposed to the surrounding environment. It is also contemplated that in certain aspects the composite system can be applied to the interior side of a curved metallic structure (e.g., the interior side of the pipeline that is used to contain or transport the fluid in the pipeline). The multi-layer composite system includes a fabric carrier that, prior to the fabric carrier having been wrapped around the structure, is impregnated or saturated with a reactive precursor, such as a resinous material (e.g., urethane, epoxy). The reactive precursor then hardens or cures to form the finished composite system reinforcement or repair of the curved metallic structure.

FIG. 3 further illustrates exemplary aspects of anomalies 36, 37, 39 of concern that might be present within a composite system repair or reinforcement. The anomalies might form during the application of the resin impregnated fabric carrier to the metallic structure or may form sometime thereafter. Examples of anomalies can include a foreign object 37 or air pocket(s) (e.g., voids 36, 39). The anomalies can form between the layers (e.g., 38a-g) of the multiplayer composite system (e.g., void 36 between layers 38a and 38b; foreign object 37 between layers 38c and 38d) or between the bond between surface of the curved metallic structure 30 and the first layer (e.g., 38a) of the multilayer composite system (e.g., void 39).

A composite system, such as the composite systems illustrates in FIGS. 2 and 3, are applied for reinforcing a section of a curved metallic structure configured to contain fluids. The composite system includes a fabric carrier impregnated (or saturated) with a uniformly dispersed reactive precursor. The reactive precursor is chemically configured to activate and harden after removal of the fabric carrier from a protective packaging providing an inert interior storage environment. In a desirable aspect, the reactive precursor includes a radiopaque substance within a range of about 3 percent to about 50 percent by weight of the reactive precursor. The impregnated fabric carrier adapted to be applied in overlapping layers to a surface of a metallic structure after activation and before hardening of the reactive precursor such that at least a first layer of overlapping layers is allowed to bond to the surface of the metallic structure.

The fabric carrier of a testable composite system can include different configurations. For example, the fabric carrier may be a woven fabric including continuous reinforcing fibers. The reinforcing fibers may be arranged in a uniaxial orientation, a biaxial orientation, or some combination thereof. It is also contemplated that the fabric carrier can include a fiberglass material, a carbon fiber material, or a combination hereof. The fiberglass, carbon, or combined material may be in the form of a cloth. Furthermore, in addition to the illustrated aspects in FIG. 1-3 of the fabric carrier being applied in overlapping layers to the exterior of a pipeline or curved metallic containment structure, the fabric carrier may also be applied in overlapping layers to an inner surface of the metallic containment structure.

The reactive precursor can include a resinous material, such as a polyurethane resin that may be pre-impregnated into the fabric carrier. The reactive pre-cursor may further be formulated to activate and harden after exposure to an aqueous solution. It would be desirable for certain reactive precursors to further be stored in a protective packaging that is air-tight to prevent premature activation and/or hardening of a pre-impregnated fabric carrier. In addition to the polyurethane resin, it is further contemplated that the reactive precursor can include a polyester resin, a vinylester resin, or any combinations thereof

In some aspects, the reactive precursor includes an epoxy material, where the epoxy material is chemically configured to activate and harden upon reaction with a curing agent. Thus, the epoxy material may comprise a two-part epoxy (e.g., an epoxide resin and a hardener) where the two-part epoxy is configured to activate and harden after the two parts (e.g., an epoxide resin and a hardener) of the two-part epoxy have been exposed to each other. The radiopaque substance may be included in the first part (e.g., the epoxide resin), the second part (e.g., the hardener), or mixed into the two-part epoxy after the first part (e.g., the epoxide resin) is exposed to the second part (e.g., the hardener). The fabric carrier can be impregnated or saturated with the epoxy resin after exposure to the curing agent. The saturated fabric carrier then needs to be applied to the curved metallic structure shortly after the resin is activated so that the composite system reinforcement can be formed before the resin cures and hardens.

As discussed above, a desirable aspect of the testable composite system is the inclusion of radiopaque substances in the reactive precursor. In some aspects, the amount of radiopaque substance falls within a range of about 3 percent to about 50 percent by weight of the reactive precursor. In some aspects, the radiopaque substance is dispersed within the reactive precursor, and may fall within additional ranges by weight of the reactive precursor, including being within a range of about 3 percent to about 10 percent by weight of the reactive precursor, a range of about 3 percent to about 15 percent by weight of the reactive precursor, a range of about 5 percent to about 15 percent by weight of the reactive precursor, a range of about 10 percent to about 15 percent by weight of the reactive precursor, a range of about 10 percent to about 20 percent by weight of the reactive precursor, a range of about 15 percent to about 25 percent by weight of the reactive precursor, or a range of about 25 percent to about 50 percent by weight of the reactive precursor.

It is contemplated that in certain aspects, the reactive precursor includes a hyperdispersant material to keep the radiopaque substances in suspension within the reactive precursor, either before activation and after hardening, after activation and hardening, or both.

Various radiopaque substances are contemplated to be included in the reactive precursor materials, such as barium sulphate, other barium-based compounds, titanium, tungsten, lead, zirconium oxide, antimony, bismuth, tin, uranium, or any combinations thereof. In some aspects, the radiopaque substance particle size is less than two microns. It is further contemplated that the radiopaque substance(s) are uniformly dispersed within the reactive precursor.

It is contemplated that a testable composite system of overlapping layers can have varying thicknesses and the curved metallic structure that is being reinforced or repaired can have varying configurations. In some aspects, the composite system of overlapping layers has a thickness within a range of about 0.1 inches to about 1.5 inches as measured perpendicular from an outer and/or an inner surface of the metallic structure to which the composite system is bonded. The metallic transport or containment structure can be a pipe having a diameter within a range of about 0.2 feet to about 6 feet. The metallic structure can include pipework, a pipeline, a transmission pipeline, a distribution pipeline, a gathering line, an oil riser, a gas riser, process piping, a tank, a vessel, a high-pressure injection line, or any combinations thereof. The material of the curved metallic structure can include carbon steel, low alloy-steel, high alloy-steel, stainless steel, aluminum, titanium, or any combinations thereof.

The fabric carrier can also have various configurations. In some aspects, the fabric carrier is a substantially rectangular segment of material. The fabric carrier may further be configured of varying widths. For example, the fabric carrier can have a width within a range of approximately 2 inches to approximately 6 inches, a range of approximately 6 inches to approximately 12 inches, or a width greater than about 12 inches and less than about 24 inches, or a width greater than about 24 inches.

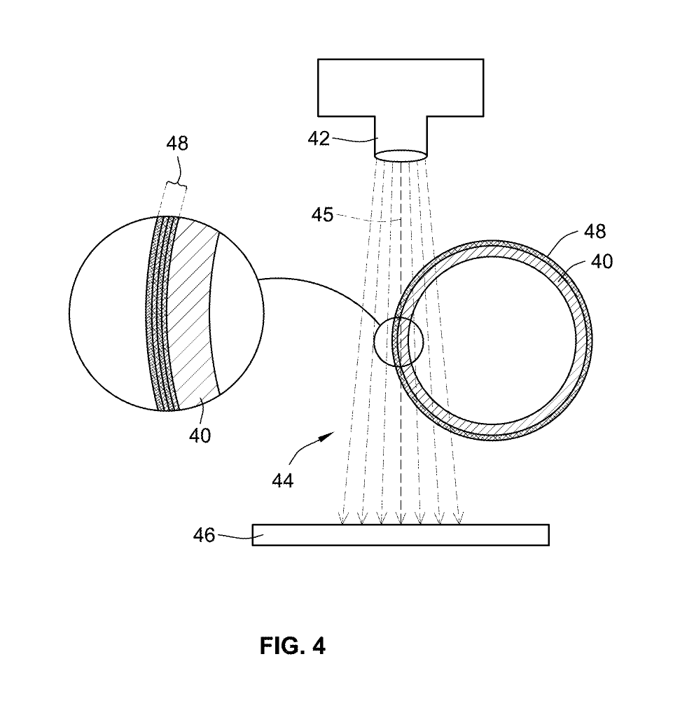

Referring now to FIG. 4, an example of the testing or inspection for a testable composite system is illustrated. A cross-section of a metallic structure 40 (e.g., a pipe) is illustrated with a multiplayer composite system 48 including a fabric carrier that was wrapped around an outer surface of the pipe. The fabric carrier has been impregnated with a resinous material including a radiopaque substance that allows layering between individual layers of the wrapped fabric carrier to be visually observed from X-ray images generated when X-rays 44 are applied from an X-ray source 42 positioned to apply X-rays 44 directed along a tangent (e.g., see X-ray 45 applied along the centerline of the X-ray field 44) to an outer circumference of the pipe 40. The radiopaque substance is configured to allow one or more anomalies (see, e.g., FIG. 3) to be identified from the generated X-ray images. The X-ray images can be generated based on received X-rays on an X-ray detector 46 (e.g., a digital detector, X-ray film). The one or more anomalies may include an air pocket or void (e.g., elements 36 or 39 in FIG. 3), a foreign object (e.g., element 37 in FIG. 3), or combinations thereof. The one or more anomalies, if any, can be located between the layers of the wrapped fabric carrier (e.g., elements 36 or 39 in FIG. 3) or the anomalies can be located between the desired bond between fabric carrier and the surface of the metallic pipe (e.g., element 39 in FIG. 3). In some aspects, it is further contemplated that the radiopaque substance can further allow fiber orientation and/or dry fiber anomalies for the fabric carrier to be identified from the generated X-ray images.

According to some aspect if the present disclosure, the X-ray source 42 has a peak operating voltage of within a range of about 70 kVp to about 400 kVp. It is also contemplated that the X-ray source can have various peak operating voltages, including a peak operating voltage of less than 70,000 volts (<70 kVp), a peak operating voltage of about 70,000 volts (about 70 kVp), a peak operating voltage of less than 125,000 volts (<125 kVp), a peak operating voltage of about 125,000 volts (about 125 kVp), a peak operating voltage of less than 400,000 volts (<400 kVp), an/or a peak operating voltage of about 400,000 volts (about 400 kVp). It is further contemplated that the radiation source might be generated from a radioactive element embedded within the X-ray source.

In some aspects of the present disclosure, a method is contemplated for inspecting a composite system that has been applied to reinforce or repair a curved metallic structure. The method can include positioning an X-ray source such that the primary radiation from the X-ray source is projected along a tangent of the outer circumference of the curved metallic structure, such as a pipeline wrapped with a hardened fabric carrier that was impregnated with a reactive precursor. The radiation penetrates through an arc of the composite system applied to the metallic structure and onto an X-ray image recording feature (e.g., an X-ray sensing device, an X-ray film). The X-ray image recording feature is exposed to X-rays from the X-ray source. Individual layers of the composite system are identifiable on an X-ray image display feature and/or from the X-ray image recording feature. One or more anomalies, if any, between the layers of the wrapped fabric carrier and/or between the fabric carrier and the surface of the metallic structure can be identified on the X-ray image display feature and/or from the X-ray image recording feature.

In some aspects, it is desirable to have a repair kit for the repair or reinforcement of a section of a metallic transport or containment structure for fluids. The repair kit can include a woven fabric carrier including a continuous reinforcing fiber and/or a non-woven fabric carrier. The fabric carrier is impregnated with a uniformly dispersed reactive precursor. In some aspects, the reactive precursor is pre-impregnated into the fabric carrier and is chemically configured to activate and harden upon exposure to an aqueous solution and/or ambient air. In other aspects, the fabric carrier is saturated with the reactive precursor and is configured to harden upon exposure to another chemical agent and/or upon exposure to ambient air. The reactive precursor includes a radiopaque substance within a range of about 3 percent to about 25 percent by weight of the reactive precursor. The reactive precursor uniformly dispersed within the reactive precursor. The fabric carrier is adapted to be applied to a metallic structure in overlapping layers of the fabric carrier.

In some aspects, the repair kit includes a moisture-impervious bag where the woven fabric carrier or the non-woven fabric carrier is sealed within the moisture-impervious bag thereby isolating the reactive precursor from premature exposure to the aqueous solution and/or ambient air. The fabric carrier may be a continuous sheet stored on a roll.

In various aspects of the repair kit, the radiopaque substance is dispersed within the reactive precursor. The radiopaque substance may be within a range of about 3 percent to about 10 percent by weight of the reactive precursor, a range of about 5 percent to about 15 percent by weight of the reactive precursor, a range of about 10 percent to about 15 percent by weight of the reactive precursor, a range of about 10 percent to about 20 percent by weight of the reactive precursor, a range of about 15 percent to about 25 percent by weight of the reactive precursor, a range of about 25 percent to about 50 percent by weight of the reactive precursor, or any combination of the ranges.

It is contemplated that inspections of composite systems using the X-ray methods described above are completed after the resin in the composite system has cured or hardened. The testable composite provide desirable inspection results for identifying multiple anomalies in a composite system, including separation between the composite system layers, the presence of foreign objects, or the separation between the composite system and the surface of the pipe being repaired or reinforced.

In some exemplary aspects of the testable composites systems exposed to X-ray inspection as described above, air voids were identified between layers for a multi-layer composite system including a fiberglass cloth tape impregnated with an epoxy resin having about 5 percent to about 15 percent of a barium sulphate (by weight of the epoxy resin) radiopaque substance. Air voids were also identified between layers for a multi-layer composite system including a carbon fiber tape impregnated with an epoxy resin having about 10 percent to about 15 percent of a barium sulphate (by weight of the epoxy resin) radiopaque substance.

While exemplary embodiments and applications of the present disclosure are illustrated and described, it is to be understood that the invention is not limited to the precise construction and compositions disclosed herein and that various modifications, changes, and variations can be apparent from the foregoing descriptions without departing from the spirit and scope of the invention as discussed below.

What is claimed is:

1. A repair kit for the reinforcement of a section of a curved metallic structure for containing fluids, the repair kit comprising:
a moisture impervious bag; and
a woven fabric carrier including a continuous reinforcing fiber, the woven fabric carrier being pre-impregnated with a uniformly dispersed polyurethane resin reactive precursor, the woven fabric carrier being sealed in the moisture impervious bag isolating the reactive precursor from premature chemical activation, the reactive precursor chemically configured to activate and harden after removal of the woven fabric carrier from the moisture-impervious bag;
wherein the reactive precursor includes a radiopaque substance within a range of about 3 percent to about 15 percent by weight of the reactive precursor, the reactive precursor uniformly dispersed within the woven fabric carrier, the radiopaque substance being suspended within the reactive precursor, the woven fabric carrier adapted to be applied to a curved metallic structure in overlapping layers of the fabric carrier.

2. The repair kit of claim 1, wherein the radiopaque substance particle size is less than two microns.

3. The repair kit of claim 1, wherein the fabric carrier is a continuous sheet stored on a roll.

4. The repair kit of claim 1, wherein the fabric carrier includes a combination of carbon fiber and fiberglass materials.

5. A composite system for reinforcing a section of a curved metallic structure configured to contain fluids, the composite system comprising:
a fabric carrier configured to be saturated with a uniformly dispersed reactive precursor, the reactive precursor chemically configured to activate and harden after removal of the reactive precursor from a protective packaging providing an inert interior storage environment;
wherein the reactive precursor includes a radiopaque substance within a range of about 3 percent to about 50 percent by weight of the reactive precursor, the saturated fabric carrier adapted to be applied in overlapping layers to a surface of a metallic structure after activation and before hardening of the reactive precursor such that at least a first layer of overlapping layers is allowed to bond to the surface of the metallic structure.

6. The composite system of claim 5, wherein the fabric carrier is a woven fabric including continuous reinforcing fibers.

7. The composite system of claim 5, wherein the reactive precursor includes a polyurethane resin and the protective packaging is air-tight, the fabric carrier being pre-saturated with the polyurethane resin.

8. The composite system of claim 5, wherein the reactive precursor is configured to activate and harden after exposure to an aqueous solution.

9. The composite system of claim 5, wherein the radiopaque substance particle size is less than two microns.

10. The composite system of claim 5, wherein the reactive precursor includes a hyperdispersant material to keep the radiopaque substances in suspension within the reactive precursor.

11. The composite system of claim 5, wherein the reactive precursor includes an epoxy material, the epoxy material chemically configured to activate and harden after reaction with a curing agent, the fabric carrier being saturated with the epoxy material prior to being applied to the metallic structure.

12. The composite system of claim 5, wherein fabric carrier includes a fiberglass material.

13. The composite system of claim 5, wherein the fabric carrier includes a carbon fiber material.

14. The composite system of claim 5, wherein the radiopaque substance includes barium sulphate, other barium-based compounds, titanium, tungsten, lead, zirconium oxide, antimony, bismuth, tin,_uranium, or any combinations thereof.

15. The composite system of claim 5, wherein the metallic structure is a pipe and the fabric carrier saturated with the reactive precursor is adapted to be wrapped in layers around an outer surface of the pipe, the radiopaque substance allowing layering between individual layers of the wrapped fabric carrier to be visually observed from X-ray images generated when X-rays are applied from an X-ray source positioned to apply X-rays directed along a tangent to an outer circumference of the pipe, the radiopaque substance further configured to allow one or more anomalies to be identified from the generated X-ray images, the one or more anomalies including an air pocket, a foreign object, or combinations thereof, the one or more anomalies being located between the layers of the wrapped fabric carrier or being located between the fabric carrier and the surface of the metallic pipe.

16. The composite system of claim 15, wherein the X-ray source has a peak operating voltage of within a range of about 70 kVp to about 400 kVp.

17. The composite system of claim 15, wherein the X-ray source has a peak operating voltage of less than 125 kVp.

18. The composite system of claim 6, wherein the reinforcing fibers are arranged in a uniaxial orientation, a biaxial orientation, or a combination thereof

19. The composite system of claim 5, wherein the fabric carrier saturated with the fabric precursor is adapted to be applied in overlapping layers to an inner surface of the curved metallic structure.

20. The composite system of claim 5, wherein the reactive precursor includes a radiopaque substance with a range of 3 percent to about 15 percent by weight of the reactive precursor.
